(19) United States
(12) Patent Application Publication
(10) Pub. No.: US 2023/0196609 A1
(43) Pub. Date: Jun. 22, 2023

(54) METHOD FOR DETERMINING A POSE OF AN OBJECT, METHOD FOR CONTROLLING A VEHICLE, CONTROL UNIT AND VEHICLE

(71) Applicant: ZF CV Systems Global GmbH, Bern (CH)

(72) Inventors: Tobias Klinger, Springe (DE); Dennis Sabelhaus, Luhden (DE); Oliver Wulf, Neustadt (DE)

(21) Appl. No.: 17/913,439

(22) PCT Filed: Mar. 22, 2021
(86) PCT No.: PCT/EP2021/057174

§ 371 Date: Sep. 22, 2022

(30) Foreign Application Priority Data
Mar. 26, 2020 (DE) 10 2020 108 416.1

(51) Int. Cl. G06T 7/73; B60D 1/36

(52) U.S. Cl. CPC G06T 7/73; B60D 1/36; G06T 2207/30204; G06T 2207/30252

(57) ABSTRACT

A method for determining a pose of an object relative to a vehicle, wherein the object has at least three markers, wherein the object is detected by at least one camera, the method including detecting the markers with the camera and generating an image, wherein one marker display is assigned to each of the markers, determining marker positions and/or marker vectors of the markers, determining a transformation matrix as a function of the marker positions and/or the marker vectors and the marker displays, wherein the transformation matrix maps the markers onto the marker display in the image, and determining an object plane formed by the markers in a second coordinate system as a function of the transformation matrix, wherein the second coordinate system is fixed relative to the vehicle, wherein the markers are spatially extended and assigned to planar marker displays in the image.

### CROSS REFERENCE TO RELATED APPLICATIONS

This application is a U.S. National Phase application under 35 U.S.C. § 371 of International Application No. PCT/EP2021/057174, filed on Mar. 22, 2021, and claims benefit to German Patent Application No. DE 10 2020 108 416.1, filed on Mar. 26, 2020. The International Application was published in German on Sep. 30, 2021 as WO 2021/191099 A1 under PCT Article 21(2).

### FIELD

The invention relates to a method for determining the pose of an object, a method for controlling a vehicle, as well as a control unit and a vehicle for carrying out the method.

### BACKGROUND

It is known from the prior art how a vehicle can be made to approach an object, such as a trailer, with the aid of one or more cameras. The environment can be captured in either 2D or 3D to estimate depth information with respect to the object.

For example, a stereo camera can be used to detect the trailer or two-dimensional or flat markers on the trailer or on components of the trailer and derive depth information from them. This is described in detail in, for example, DE 10 2016 011 324 A1, DE 10 2018 114 730 A1, WO 2018/210990 A1, or DE 10 2017 119 968 A1. From this a position and an orientation, i.e. a pose, of the respective object relative to the camera or the towing vehicle can be derived. Dependent on this, a bending angle or a distance can be determined, for example. Even a mono camera can be used to determine the pose by locating at least three markers, which are preferably applied to a flat surface of the object, in the image and, knowing the marker positions on the object, a transformation matrix is determined from which the pose of the object on which these markers are located can be derived.

According to DE 10 2018 210340 A1, it is also known to determine a distance from a swap body by comparing a size of three markers applied to a flat surface with stored sizes for these markers. The markers are coded accordingly, so that their size can be determined in advance using a camera. An angular offset can also be estimated from a relative position of individual markers relative to each other.

Detection of a bending angle using a camera is also described in US 2014 200759 A, wherein a flat marker on the trailer is observed over time from the towing vehicle and used to estimate the bending angle. JP 2002 012 172 A, US 2014 277 942 A1, US 2008 231 701 A and US 2017 106 796 A also describe a bending angle detection based on flat markers. In US 2006 293 800 A, hitching points can carry a marker to facilitate automatic detection. The marker can have a specific color, texture, or wave reflection property. DE 10 2004 025 252 B4 further describes determining the bend angle by sending radiation from a transmitter onto a semicircular or hemispherical reflector and then detecting the radiation reflected from it. Also, document DE 103 025 45 A1 describes detecting a coupling using an object detection algorithm. EP 3 180 769 B1 also describes a means of detecting a rear of a trailer via cameras and of detecting features that can be tracked from the image, e.g. an edge or a corner. These are then tracked over time, in particular to infer a bend angle between the towing vehicle and the trailer. This means that no specially applied markers are used in this case.

US 2018 039 266 A additionally describes the accessing of information from a two-dimensional bar code or QR code. In DE 10 2016 209 418 A1, a QR code can also be read with a camera to identify the trailer and forward trailer parameters to a reversing assistant. Alternatively or in addition, an RFID reader located on the trailer can read an RFID transponder attached to the towing vehicle, for example in the form of a label. This allows a position of the QR code or RFID transponder to be calculated. An orientation is not determined in this case. Also, in WO 18060192A1 a solution using radio-based transponders is provided. In DE 10 2006 040 879 B4, RFID elements on the trailer are also used for triangulation when approaching.

In WO 2008 064892 A1 an observation element is provided that has at least three auxiliary points or measurement points that can be detected by a camera. From geometric considerations, the coordinates or vectors of the centers of gravity of the auxiliary points are determined and from these, the coordinates of the measuring points relative to the camera or the image sensor. A bend angle can be determined from this.

A disadvantage of known methods is that these methods or systems are either very complex or that detection of the markers is not reliably possible under different environmental conditions. For example, flat markers cannot be reliably detected in darkness and/or under extreme or shallow viewing angles, which means that the pose of the object or the bend angle of the trailer relative to the towing vehicle cannot be reliably determined.

### SUMMARY

In an embodiment, the present disclosure provides a method for determining a pose of an object relative to a vehicle, wherein the object and the vehicle can be moved towards each other and the object has at least three markers, wherein the object is detected by at least one camera on the vehicle, the method comprising detecting the at least three markers with the camera and generating an image, wherein one marker display is assigned to each of the at least three markers in the image, determining marker positions and/or marker vectors of the markers on the detected object, determining a transformation matrix as a function of the marker positions and/or the marker vectors and as a function of the marker displays, wherein the transformation matrix maps the markers on the object onto the marker display in the image of the camera on the vehicle, and determining an object plane formed on the object by the markers in a second coordinate system as a function of the determined transformation matrix, wherein the second coordinate system is fixed relative to the vehicle for determining the pose of the object relative to the vehicle, wherein the at least three markers on the object are spatially extended and assigned to planar marker displays in the image.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a two-part vehicle with markers and cameras;

FIG. 2 shows an image recorded by the camera;

FIG. 3 shows a detail view of a front side of a trailer as an object with markers;

FIG. 4 shows a schematic view of a two-part vehicle; and

FIG. 5a, 5b, 5c show detail views of markers and surface markings.

### DETAILED DESCRIPTION

Embodiments of the present invention specify a method which enables a simple and reliable determination of the pose of an object and a subsequent processing or use of this pose for controlling the vehicle. Embodiments of the invention additionally specify a control unit and a vehicle for carrying out the method.

In an embodiment, a method for determining the pose of an object, a method for controlling a vehicle, a control unit, and a vehicle are provided.

According to some embodiments of the invention, therefore, a method is provided for determining a pose, i.e. a combination of a position and an orientation, of an object with an object width and an object height relative to a single-part or multi-part vehicle, wherein the object and the vehicle are moving relative to each other, and the object has at least three markers, preferably at least four markers, i.e. spatially extended markers or markers with a spatial geometry, such as a spherical or cylindrical or cuboidal geometry. The at least three, preferably at least four, markers are located in the same object plane on the object and no line can be drawn through the at least three, preferably at least four markers. It is assumed that the object plane described by the markers also lies approximately on the respective object, so that the pose can be estimated from the plane.

The object is captured by at least one camera on the vehicle and at least the following steps are carried out:
detecting the at least three spatially extended markers with the camera and generating an image, wherein one marker display is assigned to each of the at least three markers in the image;
determining marker positions and/or marker vectors of the spatially extended markers on the detected object, this being specified, for example, in a first coordinate system which is fixed relative to the markers or moves with the spatially extended markers;
determining a transformation matrix (homography) as a function of the marker positions and/or the marker vectors and as a function of the marker displays, wherein the transformation matrix maps the spatially extended markers on the object, or the first coordinate system, onto the marker display in the image of the camera on the vehicle or an image coordinate system; and
determining an object plane formed by the spatially extended markers on the object in a second coordinate system depending on the determined transformation matrix, wherein the second coordinate system is fixed relative to the vehicle for determining the pose of the object relative to the vehicle from the relative position between the object plane and the image plane.

To determine the transformation matrix, at least three markers are required, wherein in this case—if applicable with additional information—a transformation matrix can be at least estimated, if necessary with heuristic methods. However, it is more accurate if four or more markers are present on the respective object, as a clearly defined transformation matrix or homography matrix can be determined with known methods.

According to some embodiments of the invention, it was recognized that spatially extended markers can still be detected very well by the camera of the vehicle even at large bend angles or at extreme viewing angles, because they protrude from the object plane and can therefore be better perceived. This allows a method for determining both the position and the orientation of the object to be specified that is almost invariant to the viewing angle. This is also made possible by monocular image processing, so that stereo cameras do not need to be used to obtain depth information about the object from which the pose can be geometrically derived. This simplifies the method and can keep the costs down. The spatial markers can still be projected on the image plane with high contrast even in poor viewing conditions or ambient conditions, so that sufficient information about the object plane can still be determined from the marker displays even under different environmental conditions and viewing conditions.

This means that according to some embodiments of the invention, a reliable control of a vehicle can also be carried out by application of this method, wherein the vehicle
is controlled as part of a bend angle-based assistance function depending on a bend angle between a towing vehicle and a trailer of a multi-part vehicle derived from the determined pose of the object and/or a bend angle change, or
as part of a coupling assistance function, depending on a normal distance and/or reference distance derived from the position of the object determined between the towing vehicle as the vehicle and a trailer to be coupled as the object on which the markers are arranged, wherein the vehicle or towing vehicle is then controlled manually or automatically in such a manner that a second coupling point on the towing vehicle, for example a (semitrailer) coupling, approaches a first coupling point on the trailer to be coupled, for example a kingpin or a tiller, and that the two coupling points can be coupled together at a common pivot point, or
is controlled as part of a distance assistance function according to a normal distance and/or reference distance derived from the determined position of the object between the towing vehicle as the vehicle and a building as the object on which the markers are arranged, for example a loading ramp or a garage door or a third-party vehicle, as the object on which the at least three markers are arranged. The method for determining the pose of the object and/or the control of the vehicle are carried out on a control unit in a vehicle according to some embodiments of the invention.

It is also preferably provided that at least one of the three markers
is illuminated from the inside and/or from behind, for example via a light source arranged in a marker interior of the at least three markers, wherein the respective marker is then at least partially transparent or light-permeable, and/or
is illuminated and/or irradiated from the outside, for example via an ambient lamp, preferably on the vehicle, and/or on the object, and/or
has a self-luminous coating, such as a fluorescent coating, or similar.

This allows the spatially extended markers to be used advantageously in such a way that the object plane or the pose of the object can be detected with high contrast even in darkness. This allows the respective assistance functions to be performed reliably even in darkness. The self-luminous coating or the fluorescent coating have the advantage that no energy sources are required on the object.

It is also preferably provided that the light source in at least one of the three markers and/or the ambient lamp is controlled depending on the motion state of the vehicle and/or the object. This can save energy, as the markers are actually only actively illuminated when absolutely necessary, for example during a movement in the context of one of the driving assistance functions.

It may also be preferably provided that:
a color of the light source and/or of the ambient lamp and/or a pulse duration of the light source and/or of the ambient lamp is adjusted according to a distance between the vehicle and the object, and/or
a color of the light source and/or a pulse duration of the light source is adjusted according to the marker position on the object. This means that the markers can be selectively illuminated to additionally assist the driver, so that he/she can detect, for example using a display device, how far he/she can drive further backwards before the respective object or the object plane defined by the markers is reached. It is also possible to distinguish an object among adjacent objects in darkness by means of the color coding or flashing light coding. Such a color coding can also be achieved by the self-luminous coating, which can be applied to the respective marker in predefined colors depending on the marker position on the object.

Preferably, it is also provided that the light sources in at least one of the at least three markers will be supplied with energy from an energy source, such as a solar panel, on the object. This means that the illumination of the markers on the object is independent of the presence of a vehicle, for example in the uncoupled state. The markers on the object, for example on the trailer, can thus also be individually illuminated when parking at a depot.

It is also preferably provided that at least one of the at least three markers is formed by an outline lamp or outline lighting at the edges of the object. This means that existing elements on a trailer can be used in two ways and there is no need to install additional markers. To do this, it is only necessary to define which outline lamps should act as markers, which can be carried out using the respective marker positions or marker vectors. Knowing this, the pose of the trailer can be determined according to the mapping of the particular selected outline lamps from the object plane. Since the outline lamps are normally located on the edge of the trailer, a contour of the trailer can be easily generated from them.

It is also preferably provided that the ambient lamp emits visible and/or non-visible radiation onto the markers and that the markers have a reflective coating. This allows good visibility to be achieved in variable ways.

It is preferably also provided that on at least one of the markers or adjacent to at least one of the markers a QR code and/or a barcode and/or an Aruco marker is applied to the surface and the QR code and/or the barcode and/or the Aruco marker is detected by the camera. This allows coded information to be read out without using a separate data transmission. This makes it a simple matter to determine, for example, the marker positions and/or the marker vectors in the vehicle that are necessary for the determination of the transformation matrix in order to be able to derive the pose from the transformation matrix. Furthermore, an object width and/or an object height can be coded on the respective code or marker in a simple manner, so that this information can also be accessed from the vehicle without the need for a further data transmission or other means of reading the data.

The object width of the object and/or the object height of the object and/or a first reference point on the object, e.g. a first coupling point, kingpin on a trailer, can be determined and/or at least estimated depending on the spatial arrangement of the detected markers on the object, however. This means that a specific coding can be achieved in this way without the need for additional data transmission.

Furthermore, it may be provided that the object width of the object and/or the object height of the object and/or a first reference point on the object and/or the marker positions and/or the marker vectors are transferred to the vehicle via a communication unit on the object, e.g. in the markers, preferably via Bluetooth or RFID. This makes it possible to use wireless data transmission to facilitate the acquisition of the respective geometric information.

It is also preferably provided that the camera additionally detects surface markings which are arranged adjacent to at least one of the markers on the object, wherein the pose of the object relative to the vehicle is determined redundantly from the detected surface markings. The surface markings can also be used, for example, for a coarse adjustment or coarse determination of the pose if, for example, the determination of the pose from the spatial markers is still too inaccurate because, for example, the resolution of the camera is too low. The surface markings can be resolved accordingly without great effort, wherein the surface markings are advantageously also illuminated in the dark due to their proximity to the spatial markers, so that a dual function can be achieved by the lighting. This means that the extent of the spatial markers can be kept to a minimum, since these are only necessary for fine adjustment, for example during a coupling procedure or another approach procedure.

It is also preferably provided that the surface markings and/or the markers, at least in some cases, are arranged at edges of the object and the object width of the object and/or the object height of the object are derived from the image detected by the camera. By placing the markers or surface markings—either individually or in combination with each other—at the edges, a contour can be determined from which the respective object width or the object height can also be estimated.

It is also preferably provided that the vehicle is a single-part vehicle and the object is not connected to the vehicle, wherein the vehicle moves relative to the object and the object is a trailer to be coupled or a building, for example a loading ramp or a garage door, or a third-party vehicle. This method can be used to identify a wide variety of objects that have a flat format at least in some regions, and the pose of which relative to the vehicle, i.e. distances (translational degree of freedom) and/or angles (rotational degree of freedom), is relevant for example to coupling assistance, parking assistance, proximity assistance, or the like.

Preferably, it is also provided that the vehicle is a multi-part vehicle, i.e. consists of at least one towing vehicle and at least one trailer, and the camera is mounted on a towing vehicle and/or on a trailer coupled to it, wherein
the object is connected to the multi-part vehicle in the form of a trailer coupled to the towing vehicle, wherein the trailer moves relative to the towing vehicle or pivots relative to it at least intermittently, or
the object is not connected to the multi-part vehicle, wherein the object is a building, for example a loading ramp or a garage door, or a third-party vehicle on which the markers are arranged. This object can then be located in front of or next to the towing vehicle or behind or next to the coupled trailer, the camera being aligned accordingly with the part of the environment.

It is also preferably provided that the image of the camera is displayed on a display device, wherein the display device superimposes on the image a normal distance and/or a reference distance (as well as its lateral and vertical components) and/or a contour of the object and/or control information and/or a bend angle between the towing vehicle and the trailer and/or a first coupling point (e.g. kingpin, tiller) and/or a second coupling point (e.g. (semitrailer) coupling) and/or a trailer identifier and/or a load compartment image and/or a trailer central axis determined according to the markers, and/or a towing vehicle central axis, or axes located parallel thereto. This means that the following supplementary information, in particular from the pose, can be displayed so that the driver can perceive and respond to it in a more targeted way when performing the respective assistance functions. For example, the driver can manually counter-steer if the displayed bend angle is too high, or observe the coupling process and manually control it.

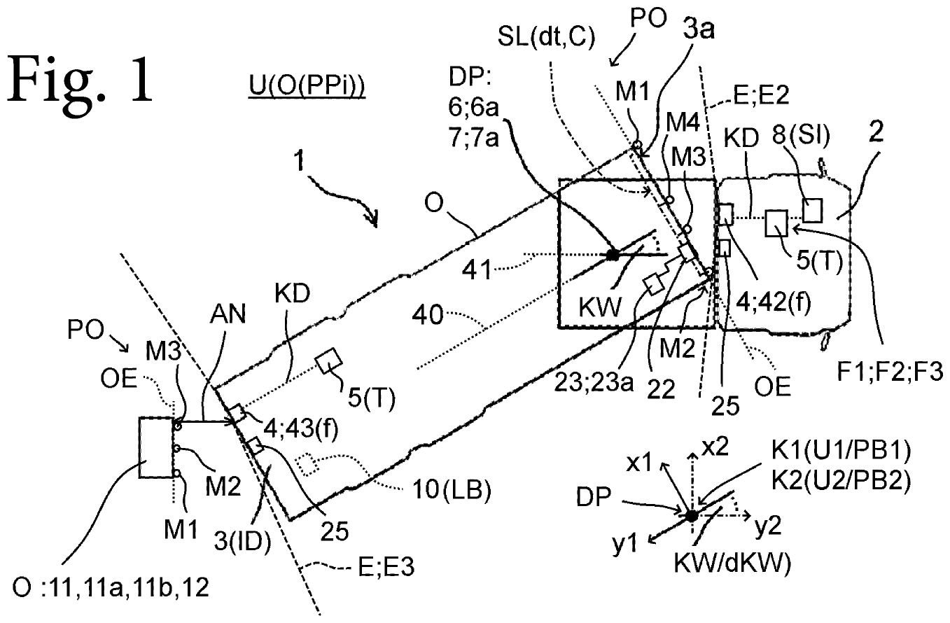

FIG. 1 shows a schematic view of a multi-part vehicle 1 consisting of a towing vehicle 2 and a trailer 3, wherein according to the embodiment shown, a camera 4 with a detection range E is mounted on both parts of the vehicle 2, 3. A towing vehicle camera 42 with a towing vehicle detection range E2 aligned to the trailer 3 is arranged on the towing vehicle 2, and a trailer camera 43 with a rear-facing trailer detection range E3 is arranged on the trailer 3. The cameras 4; 42, 43 each output camera data KD.

The vehicle 1 can be designed in multiple parts, for example as a heavy goods vehicle with a truck and a tiller trailer or turntable trailer, or as a semitrailer with a semitrailer tractor and a trailer (see FIG. 1). There may also be more than one trailer 3 provided, for example in a EuroCombi or a Road Train. However, the vehicle 1 can also be only a single-part vehicle. The alignment of the camera 4 is selected depending on the particular application. For example, the camera 4 can be an omnidirectional camera, a fisheye camera, a telephoto lens camera, or some other type of camera.

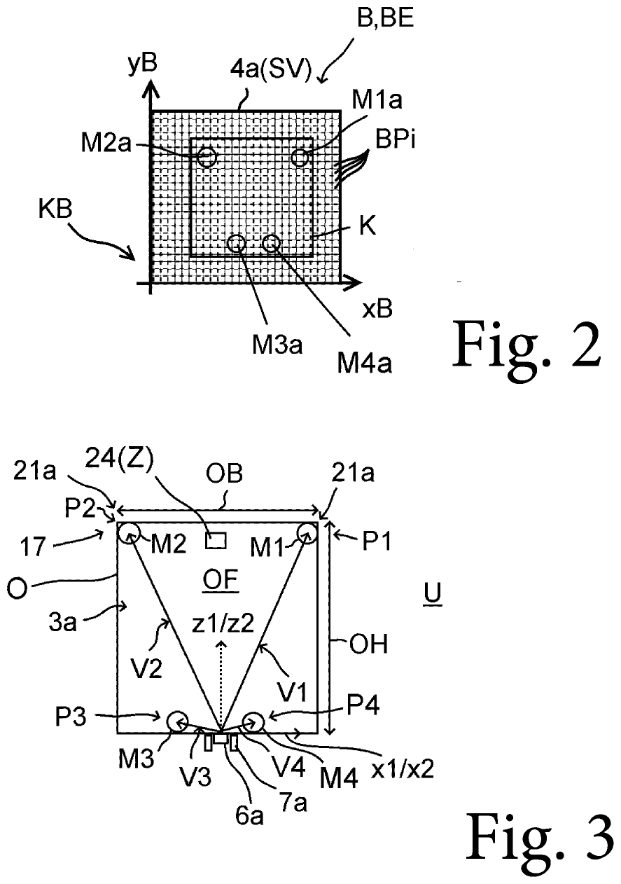

The respective camera data KD is generated depending on an environment U around the vehicle 1, which is located in the respective detection range E and which is imaged on an image sensor 4a of the respective camera 4. From the camera data KD, an image B can be created from pixels BPi with image coordinates xB, yB (see FIG. 2), wherein each image point BPi is assigned one object point PPi in the environment U. The object points PPi belong to objects O that are located in the environment U. The image B can also be displayed to the driver of the vehicle 1 via a display device 8.

The camera data KD of the respective camera 4 is transferred to a control unit 5 in the respective vehicle section 2, 3 or to a higher-level control unit 5 of the vehicle 1, which is designed to extract marker displays M1a, M2a, M3a, M4a from one or more recorded images B depending on the camera data KD, for example, by edge detection. Each marker display M1a, M2a, M3a, M4a is assigned a marker M1, M2, M3, M4 in the environment U. Furthermore, the respective control unit 5 is designed to determine an object plane OE, in which the respective markers M1, M2, M3, M4 are arranged in the environment U, from the marker displays M1a, M2a, M3a, M4a with a transformation matrix T (homography), i.e. by means of a matrix operation.

It is assumed here that at least three, preferably at least four, markers M1, M2, M3, M4 are provided and that these at least four markers M1, M2, M3, M4, as shown in FIG. 3, are located in a plane and not on a line on the object O to be detected in the environment U, for example on a preferably flat front side 3a of the trailer 3. It is also assumed that the object plane OE defined by the markers M1, M2, M3, M4 actually describes the object O in the relevant region, i.e. here on the flat front side 3a, at least approximately or possibly in an abstract way.

The four markers M1, M2, M3, M4 can then be detected from the towing vehicle camera 42, for example. However, there can also be more than four markers M1, M2, M3, M4 on the respective object O, wherein at least four markers M1, M2, M3, M4 are required to determine the transformation matrix T in order to obtain a uniquely defined transformation matrix T. In principle, however, a transformation matrix T can also be estimated with only three markers M1, M2, M3 and, if appropriate, other additional information, if necessary using heuristic methods, in which case this may then be less precise. Using the determined or estimated transformation matrix T, starting from the towing vehicle 2 a position (translational degree of freedom) as well as an orientation (rotational degree of freedom) or a combination thereof, i.e. a pose PO, of the trailer 3 in space can be estimated relative to the towing vehicle camera 42, and thus also relative to the towing vehicle 2, as explained in more detail below:

For the marker displays M1a, M2a, M3a, M4a, image coordinates xB, yB in the at least one recorded image B are first determined in an image coordinate system KB. Because the markers M1, M2, M3, M4 have a certain spatial extent and are therefore imaged two-dimensionally in the image B, i.e. multiple pixels BPi are assigned to a marker M1, M2, M3, M4, then for example the center of the respective marker display M1a, M2a, M3a, M4a can be determined and its image coordinates xB, yB further processed.

At the same time, the control unit 5 knows how the four markers M1, M2, M3, M4 are actually positioned on the object O, e.g. the front side 3a of the trailer 3, relative to each other in the object plane OE. Thus, for each marker M1, M2, M3, M4, a marker position P1, P2, P3, P4 or a marker vector V1, V2, V3, V4 can be specified (see FIG. 3). The marker vectors V1, V2, V3, V4 each contain the first coordinates x1, y1, z1 of a first coordinate system K1 with a first origin U1, wherein the marker vectors V1, V2, V3, V4 point to the respective marker M1, M2, M3, M4. The first coordinate system K1 is fixed relative to the trailer or the marker, i.e. it moves with the markers M1, M2, M3, M4. The first origin U1 can be located at a fixed first reference point PB1 on the object O, for example in one of the markers M1, M2, M3, M4 or in a first coupling point 6, in the case of a semi-trailer vehicle as the multi-part vehicle 1, for example in a kingpin 6a (see FIG. 1).

From the image coordinates xB, yB of the four marker displays M1a, M2a, M3a, M4a in the image coordinate system KB, a transformation matrix T can then be derived by the control unit 5 using the known marker vectors V1, V2, V3, V4 or marker positions P1, P2, P3, P4 of the markers M1, M2, M3, M4 in the first coordinate system K1. This transformation matrix T indicates how the individual markers M1, M2, M3, M4 as well as the object points PPi of the entire object plane OE, which according to FIG. 1 is parallel to the flat front side 3a of the trailer 3, are imaged on the image sensor 4a of the camera 4 and thus in the image B in the current driving situation of the vehicle 1. The transformation matrix T thus indicates how the object plane OE is mapped onto the image plane BE of the image sensor 4a in the current driving situation.

Thus, the transformation matrix T also contains the information as to how the trailer-fixed or marker-fixed first coordinate system K1 is aligned relative to the image coordinate system KB, wherein both translational and rotational degrees of freedom are included, so that a pose PO (combination of position and orientation) of the object plane OE relative to the image plane BE can be determined. Knowing camera parameters, such as a focal length f, an aspect ratio SV of the image sensor 4a, which are stored on or transmitted to the control unit 5, for example, a range of information can be derived from the transformation matrix T that can be used in different assistance functions Fi.

Since the transformation matrix T follows from the current driving situation of the vehicle 1, it includes, for example, a dependency on a bend angle KW between the towing vehicle 2 and the trailer 3 as well as on a normal distance AN between the camera 4 or image sensor 4a and the object plane OE. These can be determined if the position of the image sensor 4a or the image plane BE of the image sensor 4a is known in a second coordinate system K2 that is fixed relative to the camera or, in this case, also fixed relative to the towing vehicle. This allows both the image plane BE with the individual pixels BPi and the object plane OE to be expressed in second coordinates x2, y2, z2 of the fixed coordinate system K2 relative to the towing vehicle, from which the pose PO of the object O relative to the towing vehicle 2 can be determined.

Similarly, this applies to the normal distance AN, which is the perpendicular distance between the object plane OE and the image sensor 4a. If the position of the coordinate systems K1, K2 relative to each other is known from the transformation matrix T, or if the object plane OE can be specified in the second coordinate system K2, then the normal distance NA can be determined in a simple way. Instead of the normal distance NA, a reference distance AR can also be determined, which is measured between a first reference point PR1 in the object plane OE, e.g. on the trailer 3 or on a loading ramp 11a, and a second reference point PR2 on the towing vehicle 2 (see FIG. 4). If the reference points PR1, PR2 in the respective coordinate system K1, K2 are known, they can be used to derive the reference distance AR based on the transformation matrix T using simple geometric considerations.

Depending on the application, a second origin U2 of the second coordinate system K2 can be located at a fixed second reference point PB2 on the towing vehicle 2, for example in the image sensor 4a itself or in a second coupling point 7 on the towing vehicle 2, for example in a semitrailer coupling 7a of a semitrailer vehicle. The two coupling points 6 and 7 thus define a common pivot point DP, about which the towing vehicle 2 and the trailer 3 pivot relative to each other during cornering.

The person skilled in the art will easily recognize here that the coupling points 6, 7 will need to be adapted accordingly for a tiller trailer or a turntable trailer or other types of trailer, and also that a distance AN, AR and a bend angle KW can be determined for these heavy goods vehicles from the transformation matrix T as described.

In summary, via the markers M1, M2, M3, M4 it is possible to determine the pose PO of the trailer 3 and/or the pose PO of any other objects O which have such markers M1, M2, M3, M4 with known marker vectors V1, V2, V3, V4 and/or marker positions P1, P2, P3, P4. For this purpose, the image coordinate system KB is transformed into the first coordinate system K1 by means of the transformation matrix T, which allows the object plane OE to also be represented in the second coordinate system K2. From this, both translational measurement variables, e.g. the distances AN, AR, as well as rotational measurement variables, e.g. angles, between the towing vehicle 2 and the object plane OE of the respective object O, i.e. the pose PO, can be estimated.

In order to make the detection of the markers M1, M2, M3, M4 more reliable, these each have a spatial geometry, preferably a spherical geometry, i.e. they are designed in the form of a sphere. This means it can be advantageously ensured that the markers M1, M2, M3, M4 are always displayed as a circle in the recorded image B, i.e. they form a two-dimensional projection of pixels BPi on the image sensor 4a, regardless of the viewing angle of the respective camera 4. As spheres, the markers M1, M2, M3, M4 are thus invariant under viewing angle. In principle, however, markers M1, M2, M3, M4 with other spatial geometries can also be used, such as hemispheres, cubes or cylinders, which can also be detected from different viewing angles by the camera 4 with defined two-dimensional projections. These markers M1, M2, M3, M4 can be formed, for example, by fixed outline lamps 21a or the outline lighting emitted by them, which may already be present on trailers 3.

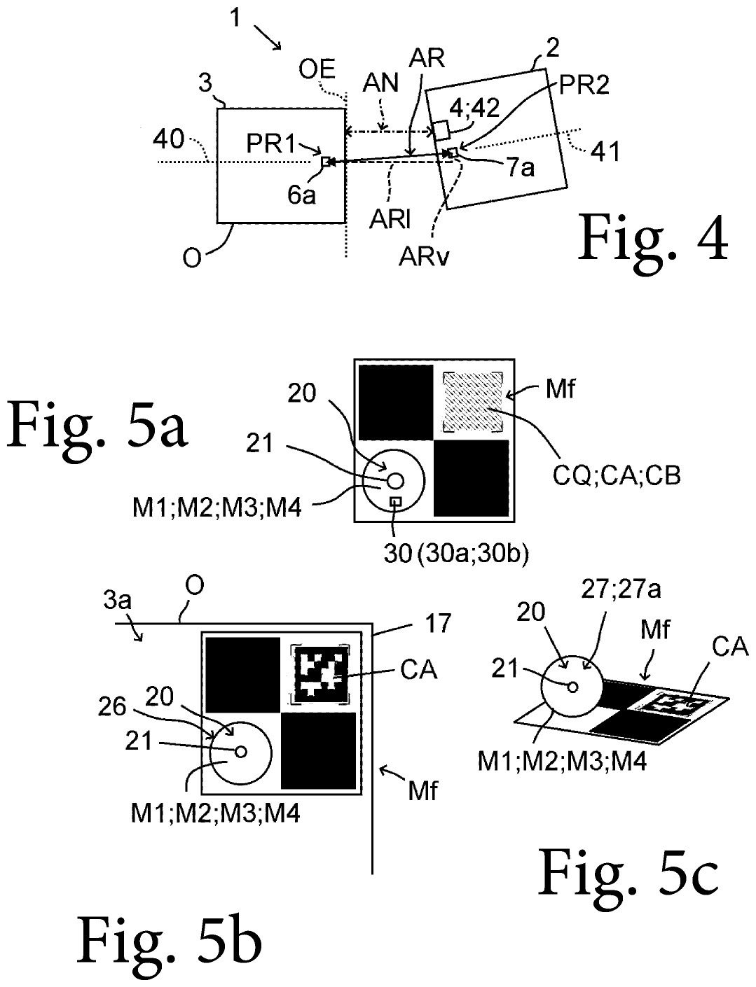

It is also possible to illuminate the markers M1, M2, M3, M4, preferably from inside or behind from a marker interior 20 with a corresponding light source 21 (see FIG. 5a, 5b, 5c), for example an LED which can be controlled by a lamp controller 22 with a lamp signal SL. The respective markers M1, M2, M3, M4 are then at least partially transparent or light-permeable to allow the electromagnetic radiation to emerge from inside or behind. This means that markers M1, M2, M3, M4 can be easily detected from different viewing angles by the camera 4 with high contrast, even in darkness. The markers M1, M2, M3, M4 or their light sources 21 are preferably supplied with energy via an energy source 23 in the trailer 3 or on the respective object O, wherein the energy source 23 can be charged by means of solar panels 23a.

In addition, it may be provided that the markers M1, M2, M3, M4 are illuminated by the lamp controller 22 depending on the motion state Z of the vehicle 1, the towing vehicle 2 and/or the trailer 3, or of the respective object O in general. For this purpose, for example, a motion sensor 24 can be provided on the trailer 3 or, in general, on the object O with the markers M1, M2, M3, M4, which can detect the motion state Z of the vehicle 1, the towing vehicle 2 and/or the trailer 3, or the object O with the markers M1, M2, M3, M4. If the vehicle 1 or towing vehicle 2 is moving relative to the respective object O or the markers M1, M2, M3, M4, the light sources 21 can be supplied with energy by the lamp controller 22 and thus illuminated.

The light sources 21 may also preferably be controlled by the lamp controller 22 depending on different lighting criteria. The lighting criteria can be the normal distance AN and/or the reference distance AR. Depending on these criteria, the lamp controller 22 can, for example, set different colors C for the light sources 21 and/or different pulse durations dt (flashing light) by frequency modulation of the lamp signal SL. For example, long pulse durations dt can be provided for large distances AN, AR and shorter pulse durations dt for short distances AN, AR. A marker position P1, P2, P3, P4 of the respective marker M1, M2, M3, M4 on the respective object O can be taken into account as a further lighting criterion. For example, the lamp controller 22 can illuminate a marker at the top left in red and a marker at the lower right in blue. This allows the driver to better distinguish adjacent objects O which each have their own markers M1, M2, M3, M4, e.g. trailers 3 parked parallel to each other.

In principle, it is also possible to make the markers M1, M2, M3, M4 visible in the dark in other ways. For example, the surfaces of the markers M1, M2, M3, M4 may be provided with a self-luminous coating 27 such as a fluorescent coating 27a, or the markers M1, M2, M3, M4 may be manufactured from a self-luminous material. This means that no energy source is required on the respective object O which has the markers M1, M2, M3, M4.

This provides a number of options for making the markers M1, M2, M3, M4 self-luminous. In principle, the markers M1, M2, M3, M4 can also be illuminated or illuminated externally, for example by an ambient lamp 25 on the towing vehicle 2 or on the respective vehicle 1, which is approaching a trailer 3, a loading ramp 11a, or in general the object O with the markers M1, M2, M3, M4, thus also allowing the markers M1, M2, M3, M4 to be made visible in darkness. The ambient lamp 25 can emit radiation in the visible or invisible spectrum, e.g. ultraviolet, and use it to illuminate the markers M1, M2, M3, M4. The markers M1, M2, M3, M4 can also be coated with an appropriate reflection coating 26 to reflect the radiation in the respective spectrum back to the camera 4 with high intensity. The ambient lamp 25 can also, like the light source 21, be activated depending on the motion state Z and other lighting criteria to illuminate the markers M1, M2, M3, M4 in different colors C and/or with different pulse durations dt (flashing light), e.g. depending on the normal distance AN and/or the reference distance AR or the motion state Z.

This distinguishes embodiments of the invention from conventional methods in which planar surface markings Mf are used alone or in combination with QR codes CQ and/or barcodes CB and/or Aruco markers CA to detect a pose PO of the object plane OE of the object O, wherein the visibility of the surface markings Mf is very limited under wide viewing angles and in darkness. Despite these disadvantages, provision can be made to combine the spatially extended markers M1, M2, M3, M4 with such surface markings Mf (see FIG. 5). The surface markings Mf can also be illuminated in darkness by the adjacently positioned light sources 21 of the markers M1, M2, M3, M4 or by their self-luminosity or by the ambient lamp 25, so that they can still be recognized even in darkness. The surface markers Mf can also be provided with a self-luminous coating 27 or a reflective coating 26 in order to be more easily recognizable even in darkness or to be able to reflect the radiation of the ambient lamp 25 back to the respective camera 4 with high intensity.

In addition, the surface markings Mf can be used to detect the object O with the markers M1, M2, M3, M4, for example the trailer 3, over a longer distance of up to 10 m if for some reason the markers M1, M2, M3, M4 cannot be sufficiently resolved by the camera 4. This means that a coarse detection can be carried out initially using the surface markings Mf and depending on the result, the camera 4 can approach the respective object O in a targeted way until the camera 4 can also sufficiently resolve the markers M1, M2, M3, M4. Then, the object plane OE can be determined using only the markers M1, M2, M3, M4 or using the markers M1, M2, M3, M4 and the surface markings Mf, so that redundant information can be used in the determination.

The surface markings Mf can also provide additional information that can assist in determining the position of the object plane OE in space. For example, the surface markings Mf may be positioned adjacent to the edges 17 of the front side 3a of the trailer 3 or the respective object O. This means that not only can the object plane OE itself be determined, but also the extent of the respective object O or the object surface OF, which the respective object O occupies within the determined object plane OE. Thus, an object width OB and an object height OH of the front side 3a or of the respective object O within the determined object plane OE can be estimated, if it is assumed that the markers M1, M2, M3, M4 or at least some of the markers M1, M2, M3, M4 bound the object O at the edges.

The markers M1, M2, M3, M4 themselves or at least some of the markers M1, M2, M3, M4 can also be placed at the edges 17 in this way, so that from their marker positions P1, P2, P3, P4 or marker vectors V1, V2, V3, V4 the object width OB and the object height OH of the object O within the determined object plane OE can be estimated. If more than four markers M1, M2, M3, M4 and/or surface markings Mf are provided, they can also bound a polygonal object surface OF in the object plane OE, thus allowing a shape or a contour K of the object O to be extracted within the determined object plane OE. In this way, the shape of the entire object O can be inferred, for example in the case of a trailer 3.

The object width OB and/or the object height OH can thus be determined or at least estimated on the basis of different reference points. In the case of a trailer 3, this will be the corresponding extent of the front side, and in the case of a loading ramp 11a or a garage door 11b, its surface extent. If it is unknown whether the respective reference points (markers, surface markings, etc.) are located at the edges, at least one approximate (minimum) boundary of the respective object O and thus an approximate (minimum) object width OB and/or approximate (minimum) object height OH can be estimated from this.

In addition, the surface markings Mf can have QR codes CQ or barcodes CB or Aruco markers CA (see FIG. 5a). In these markers, the object width OB and/or the object height OH of the object O, in particular within the determined object plane OE, and/or the marker vectors V1, V2, V3, V4 and/or the marker positions P1, P2, P3, P4 relative to the first reference point BP1 (e.g. the first coupling point 6 on the trailer 3) can be encoded. For example, the control unit 5 which is connected to the camera 4 can define the first coordinate system K1 or extract the corresponding information from the transformation matrix T even without reading in this data beforehand. The QR codes CQ or barcodes CB or Aruco markers CA can be created, for example, after calibration of the markers M1, M2, M3, M4 and then applied to the surface of the respective object O near to the marker as part of the surface markings Mf.

It is also feasible to encode geometric information of the object O, e.g. the object width OB and/or the object height OH of the object O, in particular within the determined object plane OE, and/or the marker vectors V1, V2, V3, V4 and/or the marker positions P1, P2, P3, P4 relative to the first reference point BP1 (e.g. the first coupling point 6 on the trailer 3) using the marker positions P1, P2, P3, P4 on the respective object O. Thus, the spatial arrangement of the markers M1, M2, M3, M4 can be used to identify, for example, where the first reference point BP1, e.g. the first coupling point 6, is located. For example, in the case of four markers M1, M2, M3, M4, one marker each can be arranged at the top left, top center and top right, and another marker at the bottom center. This spatial arrangement is then assigned to a specific defined position of the first coupling point 6, which is known to the control unit 5. Similarly, at another defined position of the first coupling point 6, a different spatial arrangement of the markers M1, M2, M3, M4 can be assigned, wherein further markers can also be provided for further subdivision.

In principle, the QR codes CQ or barcodes CB or Aruco markers CA with the corresponding encoding can also be applied to the markers M1, M2, M3, M4 in an appropriately curved form, so that the respective data for defining the first coordinate system K1 or for identifying the marker positions P1, P2, P3, P4 of the markers M1, M2, M3, M4 can be detected by the camera 4. Furthermore, in one or more markers M1, M2, M3, M4 communication units 30 can be arranged (see FIG. 5a), which are designed to provide this data (the object width OB and/or the object height OH of the object O, in particular within the determined object plane OE, and/or the marker vectors V1, V2, V3, V4 and/or the marker positions P1, P2, P3, P4 relative to the first reference point BP1) wirelessly, e.g. via Bluetooth 30a, RFID 30b, etc., to the towing vehicle 2 or the control unit 5, e.g. a trailer identifier ID.

The markers M1, M2, M3, M4 designed in this way can be used to perform a number of assistance functions Fi, depending on the vehicle type, as follows.

As already described, the markers M1, M2, M3, M4 on a multi-part vehicle 1 consisting of a towing vehicle 2 and a trailer 3 can preferably be used to continuously determine the bend angle KW between these two parts. This bend angle KW can then be used, for example, to steer the multi-part vehicle 1 when reversing and/or during a parking maneuver, or to estimate the stability during cornering via a bend angle change dKW. This allows a bend-angle-based assistance function F1 to be provided.

In addition, the normal distance AN or the reference distance AR can be used to enable a coupling assistance function F2. For example, the coupling points 6, 7 can be selected as reference points PR1, PR2, wherein a lateral reference distance AR1 and a vertical reference distance ARv can be determined from the resulting reference distance AR as supporting values. These also follow from the pose PO of the object plane OE relative to the image sensor 4a or the object plane OE in the second coordinate system K2, which is determined using the transformation matrix T. This enables a targeted approach by the second coupling point 7 on the towing vehicle 2 to the first coupling point 6 on the trailer 3 if the towing vehicle 2 is suitably controlled manually or automatically depending on the components of the reference distance AR1, ARv.

Alternatively or in addition, depending on the determined relative position of the object plane OE or the front side 3a of the trailer 3, trailer information AI can also be created and visually displayed to the driver by a display device 8 together with the recorded image B of the camera 4. For example, the trailer information AI displayed by the display unit 8 can include a trailer identifier ID, the normal distance AN and/or the reference distance AR, the bend angle KW, etc. The display device 8 can overlay the trailer information AI on the image B recorded by the respective camera 4, so that both the image of the environment U and the trailer information Ai are displayed. For example, to provide a clear display the trailer information AI can be scaled according to the distance AN, AR and overlaid in the image region of the image B in which the front side 3a of the trailer 3 is displayed.

It may also be provided that the display device 8 displays the contour K, for example, of the front side 3a of the trailer 3 or of the entire trailer 3 as the trailer information AI. The contour K is modeled from the object plane OE determined via the markers M1, M2, M3, M4 depending on the stored or determined object width OB and object height OH of the trailer 3. The marker positions P1, P2, P3, P4 of the markers M1, M2, M3, M4 can also be taken into account if, for example, these are arranged at the edges 17 of the front side 3a. The trailer contour K can be displayed individually or overlaid on the image B. This can facilitate, for example, maneuvering or coupling in darkness.

Furthermore, the trailer information AI displayed by the display unit 8 can be the first or second coupling point 6, i.e. the kingpin 6a or the semitrailer coupling 7a, either individually or overlaid on the image B. Since, for example, the kingpin 6a cannot be seen directly in the image B of the camera 4, this overlay can be used, if necessary in combination with the displayed reference distance AR, to facilitate coupling or a coupling process can be closely monitored, for example, even in the dark.

In addition, a trailer central axis 40 of the trailer 3 and a towing vehicle central axis 41 of the towing vehicle 2 can be overlaid on the image B by the display unit 8 as the trailer information AI. While the towing vehicle central axis 41 is known, the trailer central axis 40 can be modeled from the object plane OE determined via the markers M1, M2, M3, M4 depending on the stored or determined object width OB and object height OH of the trailer 3. The marker positions P1, P2, P3, P4 of the markers M1, M2, M3, M4 can also be taken into account if, for example, these are arranged at the edges 17 of the front side 3a. The angle between the trailer central axis 40 of the trailer 3 and a towing vehicle central axis 41 of the towing vehicle 2 is then the bend angle KW, which can be additionally displayed. The display or overlay of the central axes 40, 41 allows the driver to position both lines relative to each other, e.g. to place them on top of each other to provide assistance to the driver, for example, during a coupling process. To provide the same effect, an axis can also be drawn parallel to the trailer central axis 40 of the trailer 3 or the towing vehicle central axis 41 of the towing vehicle 2.

In addition, the display unit 8 can also overlay control information SI on the image B, which shows the driver, for example by means of arrows, the direction in which to steer the towing vehicle 2 in order to approach the second coupling point 6 to the first coupling point 7. For example, the control information SI can be determined by a corresponding control algorithm on the control unit 5, which determines a suitable trajectory.

Furthermore, a load compartment camera 10 can be provided in the load compartment 10a of the trailer 3, which can detect loaded freight. The load compartment images LB recorded by the load compartment camera 10 can be displayed by the display device 8. The load compartment images LB can be placed over the images B of the camera 4 in such a way that they are displayed in the region of the trailer 3, which is verified by the markers M1, M2, M3, M4. This allows the operator to check the freight or identify what the trailer 3 captured by the camera 4 has loaded, even during operation. This can take place during an approach operation or even when driving past the trailer 3, e.g. at a depot 11a, in order to visually verify whether a trailer 3 is assigned to the towing vehicle 2.

In addition to an internal application in a multi-part vehicle 1 as described, as part of a distance assistance function F3 it can be provided that the markers M1, M2, M3, M4 are positioned, for example, on a building 11, e.g. a loading ramp 11a, a garage door 11b, etc., or on a moving or stationary third-party vehicle 12 or on other obstacles in the environment U, which can each be detected by the camera 4 as potentially relevant objects O.

The markers M1, M2, M3, M4 can also be used in the described manner to determine a relevant object plane OE of these objects 0 if the marker positions P1, P2, P3, P4 and/or the marker vectors V1, V2, V3, V4 are known. These can then also be combined with surface markings Mf and/or light sources 21 and/or a self-luminous coating 27 and/or reflection coating 26 in the described manner, in order to enable the simplest and most reliable possible determination of the object plane OE under different environmental conditions.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

1 vehicle

2 towing vehicle

3 trailer

3a front side of trailer 3

4 camera

42 towing vehicle camera

43 trailer camera

4a image sensor

5 control unit

6 first coupling point

6a kingpin

7 second coupling point

7a semitrailer coupling

8 display device

10 load compartment camera

11 building

11a loading ramp

11bgarage door

12 third-party vehicle

17 edges of object O

20 marker interior

21 light source

21a outline lamps

22 lamp controller

23 energy source

23a solar panel

24 motion sensor

25 ambient lamp

26 reflection coating

27 self-luminous coating

27a fluorescent coating

30 communication unit

30a Bluetooth

30b RFID

40 trailer central axis

41 towing vehicle central axis

AN normal distance

AR reference distance

AR1 lateral reference distance

ARv vertical reference distance

B image

BE image plane

BPi pixels

C color

CQ QR code

CB barcode

CA Aruco marker

DP pivot point

dt pulse duration

dKW bend angle change

E detection range

E2 towing vehicle detection range

E3 trailer detection range

f focal length

F1 bending-angle-based assistance function

F2 coupling assistance function

F3 distance assistance function

ID trailer identifier

K contour of object O

K1 first coordinate system (fixed relative to marker)

K2 second coordinate system (fixed relative to camera)

KB image coordinate system

KD camera data

KW bend angle

LB load compartment image

M1, M2, M3, M4 markers

M1a, M2a, M3a, M4a marker display

Mf surface marking

O object

OB object width

OE object plane

OF object surface

OH object height

P1, P2, P3, P4 marker position

PB1 first reference point

PB2 second reference point

PO pose

PPi object point

PR1 first reference point

PR2 second reference point

SI control information

SL lamp signal

SV aspect ratio of image sensor 4a

T transformation matrix

U environment

U1 first origin

U2 second origin

V1, V2, V3, V4 marker vector

Z motion state

xB, yB image coordinates

x1, y1, z1 first coordinates in the first coordinate system K1

x2, y2, z2 second coordinates in the second coordinate system K2

1. A method for determining a pose of an object relative to a vehicle, wherein the object and the vehicle can be moved towards each other and the object has at least three markers, wherein the object is detected by at least one camera on the vehicle, the method comprising:
detecting the at least three markers with the camera and generating an image, wherein one marker display is assigned to each of the at least three markers in the image;
determining marker positions and/or marker vectors of the markers on the detected object;
determining a transformation matrix as a function of the marker positions and/or the marker vectors and as a function of the marker displays, wherein the transformation matrix maps the markers on the object onto the marker display in the image of the camera on the vehicle; and
determining an object plane formed on the object by the markers in a second coordinate system as a function of the determined transformation matrix, wherein the second coordinate system is fixed relative to the vehicle for determining the pose of the object relative to the vehicle,
wherein
the at least three markers on the object are spatially extended and assigned to planar marker displays in the image.

2. The method according to claim 1, wherein the camera detects at least three markers, which are spherical or cylindrical or cuboidal.

3. The method according to claim 1, wherein at least one of the at least three markers:
is illuminated from the inside and/or from behind, via a light source arranged in a marker interior of the at least three markers and/or
is illuminated and/or irradiated from the outside via an ambient lamp, and/or
has a self-luminous coating.

4. The method according to claim 3, wherein the light source and/or the ambient lamp is controlled according to a motion state of the vehicle and/or of the object.

5. The method according to claim 3, wherein:
a color of the light source and/or of the ambient lamp and/or a pulse duration of the light source and/or of the ambient lamp is adjusted according to a distance between the vehicle and the object, and/or
a color of the light source and/or a pulse duration of the light source is adjusted according to the marker position on the object, and/or
a color of the self-luminous coating on at least one of the at least three markers is adjusted according to the marker position on the object.

6. The method according to claim 3, wherein the light source in at least one of the at least three markers is supplied with energy by an energy source on the object.

7. The method according to claim 3, wherein at least one of the at least three markers is formed by an outline lamp at edges of the object.

8. The method according to claim 3, wherein the ambient lamp emits visible and/or non-visible radiation on the markers and the markers have a reflective coating.

9. The method according to claim 1, wherein the object has an object width and an object height.

10. The method according to claim 9, wherein on at least one of the markers or adjacent to at least one of the markers a QR code and/or a barcode and/or an Aruco marker is applied to a surface and the QR code and/or the barcode and/or the Aruco marker is detected by the camera.

11. The method according to claim 10, wherein the QR code and/or the barcode and/or the Aruco marker detected by the camera is used to determine the object width of the object and/or the object height of the object and/or the marker positions and/or the object vectors.

12. The method according to claim 9, wherein the object width of the object and/or the object height of the object and/or a first reference point on the object are determined and/or at least estimated according to the a spatial arrangement of the detected markers on the object relative to one another.

13. The method according to claim 9, wherein the object width of the object and/or the object height of the object and/or a first reference point on the object and/or the marker positions and/or the marker vectors are transmitted to the vehicle via a communication unit on the object.

14. The method according to claim 9, wherein the camera additionally detects surface markings, which are arranged adjacent to at least one of the markers on the object, and wherein the pose of the object relative to the vehicle is determined redundantly from the detected surface markings.

15. The method according to claim 14, wherein the surface markings and/or the markers at least in some cases are arranged at edges of the object and the object width of the object and/or the object height of the object are derived from the image detected by the camera.

16. The method according to claim 1, wherein:
the vehicle is a single-part vehicle and the object is not connected to the vehicle, wherein the vehicle moves relative to the object and the object is a trailer to be coupled or a building, for example a loading ramp or a garage door or a third-party vehicle, or wherein
the vehicle is a multi-part vehicle and the camera is arranged on a towing vehicle and/or on a trailer coupled to the towing vehicle, wherein:
the object is connected to the multi-part vehicle, the object being a coupled trailer which moves relative to the towing vehicle at least intermittently, or
the object is not connected to the multi-part vehicle, wherein the object is a building, for example a loading ramp or a garage door, or a third-party vehicle.

17. The method according to claim 1, wherein the image of the camera is displayed on a display device, wherein the display device superimposes on the image a normal distance and/or a reference distance and/or a contour of the object and/or control information and/or a bend angle between the towing vehicle and the trailer and/or a first coupling point and/or a second coupling point and/or a trailer identifier and/or a load compartment image and/or a trailer central axis that is determined according to the markers and/or a towing vehicle central axis.

18. A method for controlling a vehicle as a function of a pose of an object relative to the vehicle, the pose of the object being determined in a-the method according to claim 1, wherein the vehicle:
is controlled as part of a bend-angle-based assistance function according to a bend angle, derived from the determined pose of the object, between a towing vehicle and a trailer of a multi-part vehicle and/or a bend-angle change, or
is controlled as part of a coupling assistance function, according to a normal distance and/or reference distance derived from the determined pose of the object between the towing vehicle as the vehicle and a trailer to be coupled as the object on which the at least three markers are arranged, in such a way that a first coupling point on the trailer to be coupled approaches a second coupling point on the towing vehicle and the two coupling points are coupled together at a common pivot point, or
is controlled as part of a distance assistance function according to a normal distance and/or reference distance derived from the determined pose of the object between the towing vehicle as the vehicle and a building as the object on which the at least three markers are arranged, or a third-party vehicle as the object on which the at least three markers are arranged.

19. A control unit for carrying out the method according to claim 1.

20. A vehicle having the control unit according to claim 19, wherein the vehicle is single-part or multi-part and the at least one camera is arranged on the towing vehicle and/or the trailer of the multi-part vehicle.

21. The vehicle according to claim 20, wherein the at least three markers are arranged on a front side of the trailer.
